(19) United States
(12) Patent Application Publication
(10) Pub. No.: US 2009/0152902 A1
(43) Pub. Date: Jun. 18, 2009

(54) FRONT STRUCTURE OF VEHICLE

(75) Inventors: Kenji Sugasaki, Hiroshima-shi (JP); Nobuaki Omokawa, Hiroshima-shi (JP)

Correspondence Address: Studebaker & Brackett PC, 1890 Preston White Drive, Suite 105, Reston, VA, 20191, US

(73) Assignee: MAZDA MOTOR CORPORATION, Hiroshima (JP)

(21) Appl. No.: 12/330,792

(22) Filed: Dec. 9, 2008

(30) Foreign Application Priority Data
Dec. 12, 2007 (JP) 2007-320343

(51) Int. Cl. B62D 21/02

(52) U.S. Cl. 296/203.02

(57) ABSTRACT

Disclosed is a vehicle front structure which comprises a rectangular frame-shaped shroud frame 18 disposed in a front of an engine compartment to internally support a radiator 12, and a fresh air duct 22 disposed to allow an air inlet port thereof to be opened in a frontward direction of a vehicle, and supply intake air to an engine via an air cleaner, wherein the shroud frame 18 has a fresh air duct-connection opening 26 formed in an upper portion thereof at a position on the side of a first one of opposite ends of the upper portion in a lateral direction of the vehicle, and the fresh air duct 22 is disposed to allow the air inlet port to be connected to the fresh air duct-connection opening 26 of the shroud frame 18, and extend in the lateral direction toward the other second end of the upper portion so as to be connected to the air cleaner disposed on the side of the second end, wherein at least a portion of the fresh air duct is disposed between an upper deck 28 of the shroud frame 18 and an upper end of the radiator 12 located beneath the upper deck.

### BACKGROUND OF THE INVENTION

1. Field of the Invention

The present invention relates to a front structure of a vehicle having an engine compartment arranged in a front thereof, and more particularly to air intake systems for supplying combustion air to an engine of a vehicle.

2. Description of the Background Art

In a vehicle having an engine compartment arranged in a front thereof, a radiator is disposed rearward of a front grill in a frontward-rearward (i.e., longitudinal) direction of the vehicle to cool an engine coolant by outside air passing through the front grill, and a fresh air duct having an inlet port for introducing fresh outside air other than the outside air passing through the front grill is disposed to allow the inlet port to be located above the radiator, and supply the outside air introduced from the inlet port, to the engine via an air cleaner.

It is desirable for the fresh air duct to form an air passage therein in a linear shape having a lower flow resistance in view of enhancing air intake efficiency, and to increase an overall length thereof as long as possible in view of reducing air intake noise. Such a fresh air duct is disclosed, for example, JP Hei 08-114120A (hereinafter referred to as “Patent Document 1”). A fresh air duct disclosed in the Patent Document 1 is disposed to allow an inlet port thereof to be located on the side of a first one of opposite ends of a fan shroud in a widthwise (i.e., lateral) direction of a vehicle, and extend in the lateral direction toward the other second end of the fan shroud so as to be connected to an air cleaner disposed on the side of the second end. This makes it possible to achieve a linear-shaped longer fresh air duct.

The fresh air duct disclosed in the Patent Document 1 is located rearward of and above a radiator, i.e., located above the fan shroud attached to a rearward side of the radiator in a longitudinal direction of the vehicle, to thereby reduce a front upper space of an engine compartment. This is undesirable for recent vehicles required to downsize an engine compartment in connection with a need for reduction in vehicle size and increase in passenger or utility space.

### SUMMARY OF THE INVENTION

It is therefore an object of the present invention to provide a vehicle front structure comprising a fresh air duct capable of ensuring high air intake efficiency and reducing air intake noise without reducing a front upper space of an engine compartment.

In order to achieve this object, the present invention provides a vehicle front structure which comprises a rectangular frame-shaped shroud frame disposed in a front of an engine compartment to internally support a radiator, and a fresh air duct disposed to allow an air inlet port thereof to be opened in a frontward direction of a vehicle, and supply intake air to an engine via an air cleaner, wherein the shroud frame has a fresh air duct-connection opening formed in an upper portion thereof at a position on the side of one of opposite ends of the upper portion in a lateral direction of the vehicle, and the fresh air duct is disposed to allow the air inlet port to be connected to the fresh air duct-connection opening of the shroud frame, and extend in the lateral direction toward the other second end of the upper portion so as to be connected to the air cleaner disposed on the side of the second end, wherein at least a portion of the fresh air duct is disposed between an upper deck of the shroud frame and an upper end of the radiator located beneath the upper deck.

In the vehicle front structure of the present invention, at least a portion of the fresh air duct is disposed between the upper end of the radiator and the upper deck of the shroud frame internally supporting the radiator. Further, in order to reduce a flow resistance and increase an inner volume, the fresh air duct is disposed to allow the air inlet port to be located on the side of the first end of the upper portion of the shroud frame, and extend in the lateral direction toward the air cleaner disposed on the side of the second end of the upper portion of the shroud frame. This makes it possible to ensure high air intake efficiency and reduce air intake noise without reducing a front upper space of the engine compartment.

These and other objects, features and advantages of the present invention will become apparent upon reading the following detailed description along with the accompanying drawings.

### BRIEF DESCRIPTION OF THE DRAWINGS

FIG. 1 is a perspective view showing a vehicle front structure according to one embodiment of the present invention.

FIG. 2 is a back view showing a shroud frame, when viewed from the side of a radiator.

FIG. 3 is a sectional view taken along the line X-X in FIG. 2.

FIG. 4 is a top plan view showing a fresh air duct, when viewed downwardly from the side of an upper deck of the shroud frame.

FIG. 5 is a fragmentary enlarged view showing the fresh air duct in FIG. 4.

### DESCRIPTION OF THE PREFERRED EMBODIMENTS

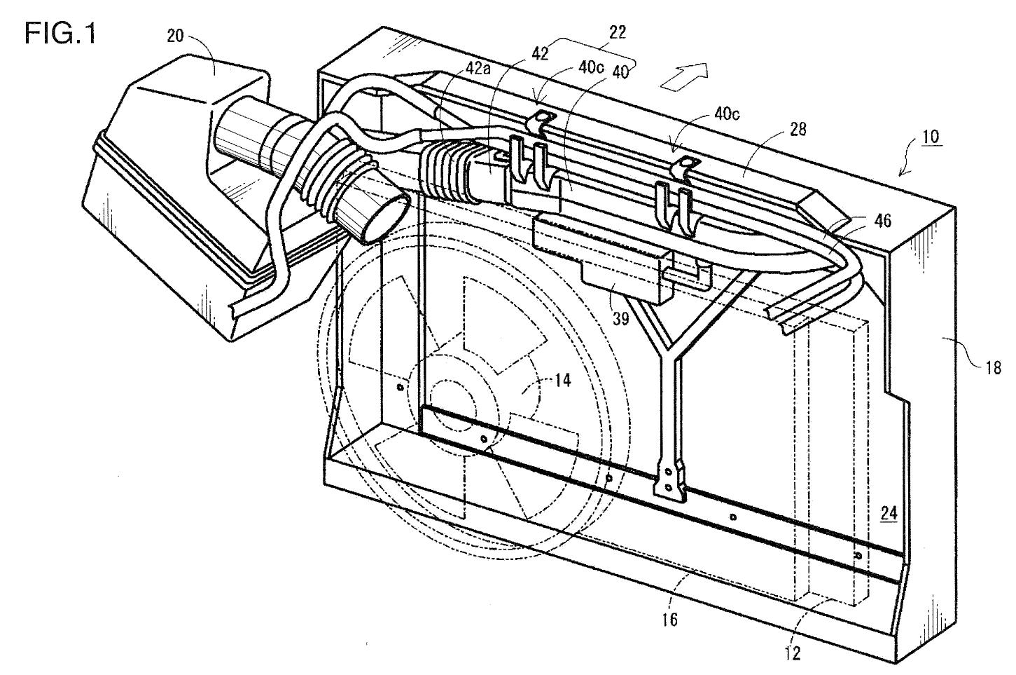

FIG. 1 shows a vehicle front structure according to one embodiment of the present invention.

The vehicle front structure designated by the reference numeral 10 in FIG. 1 is disposed in a frontmost position of an engine compartment and behind a front grill (not shown) and an opening of a front skirt (not shown) of a vehicle body (a direction indicated by the outline arrow in FIG. 1 is a frontward direction of a vehicle).

The vehicle front structure 10 comprises a radiator 12 adapted to coolant for an engine (not shown) by outside air passing through the front grill, a fan shroud 16 disposed behind the radiator 12 and internally provided with a fan 14 adapted to introduce outside air into the radiator 12, a rectangular frame-shaped shroud frame 18 internally supporting the radiator 12 and the fan shroud 16, and a fresh air duct 22 adapted to introduce outside air therethrough, and supply combustion air to the engine via an air cleaner 20.

The radiator 12 is disposed to be located immediately behind the front grill (specifically, the shroud frame 18 supporting the radiator 12 is attached immediately behind the front grill).

The fan shroud 16 is a member for supporting the fun 14 adapted to introduce (suck) outside air into (through) the radiator 12 via the front grill. The fan shroud 16 is attached to a rear of the radiator 12.

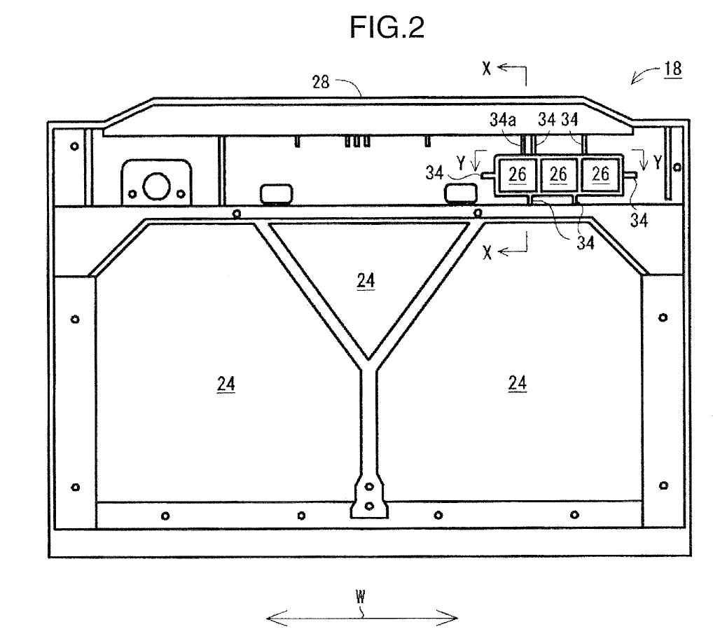

As also shown in FIG. 2 which is a back view showing the shroud frame 18 (when viewed from the side of the radiator 12), the shroud frame 18 is formed in a rectangular frame shape to have an opening 24 for allowing outside air passing through the front grill and the opening of the front skirt to reach the internally supported radiator 12. In another respect, the shroud frame 18 is formed in an oblong box shape to have, in a bottom wall thereof, an opening 24 for supplying outside air therethrough (the opening 24 will hereinafter be referred to as “radiator-cooling opening 24”).

As shown in FIG. 2, the shroud frame 18 also has a fresh air duct-connection opening 26 adapted to allow an after-mentioned air inlet port of the fresh air duct 22 to be connected thereto. The fresh air duct-connection opening 26 is formed in an upper portion of the shroud frame 18 between the radiator-cooling opening 24 and an upper deck 28 of the shroud frame 18, at a position on the side of a first one of opposite ends of the upper portion of the shroud frame 18 in a widthwise (i.e., lateral) direction W of the vehicle, and a peripheral edge defining the fresh air duct-connection opening 26 is formed to extend a rearward direction of the vehicle by a given distance.

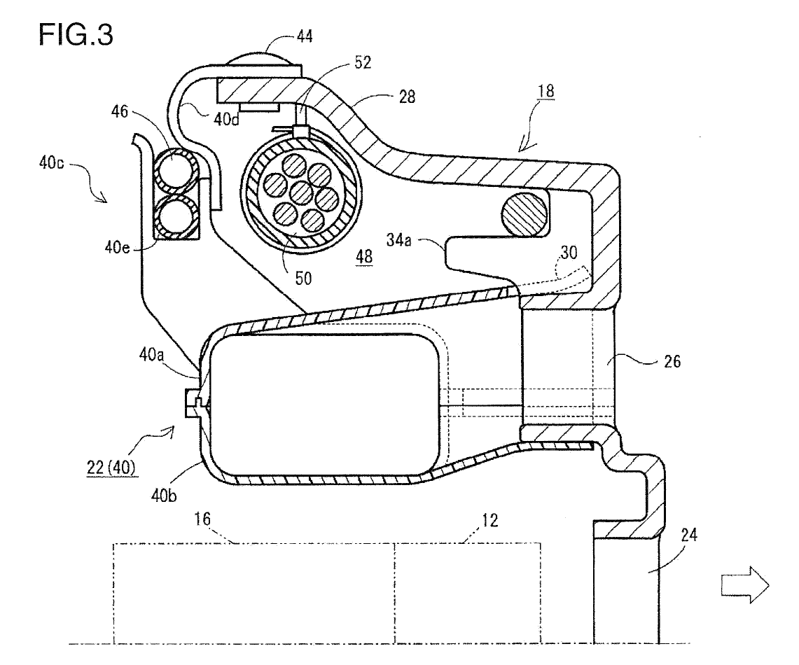

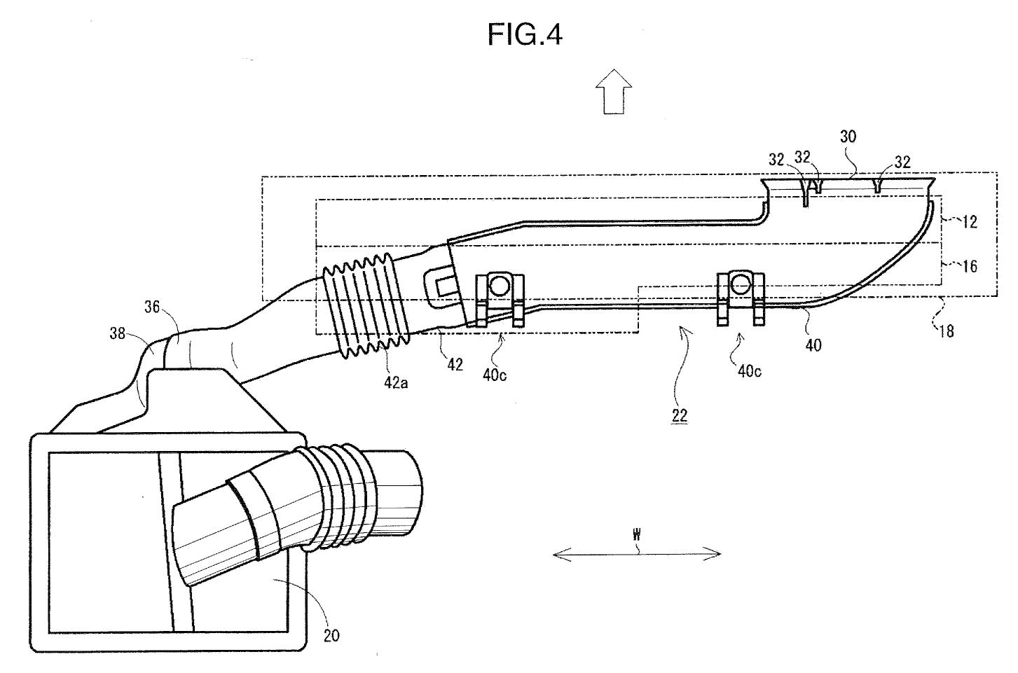

As shown in FIG. 3 which is a sectional view taken along the line X-X in FIG. 2, and FIG. 4 which is a top plan view showing the fresh air duct 22 (when viewed downwardly from the side of the upper deck 28 of the shroud frame 18), the fresh air duct 22 has an air inlet port 30 which is opened in the frontward direction of the vehicle, and adapted to be connected to the fresh air duct-connection opening 26 of the shroud frame 18.

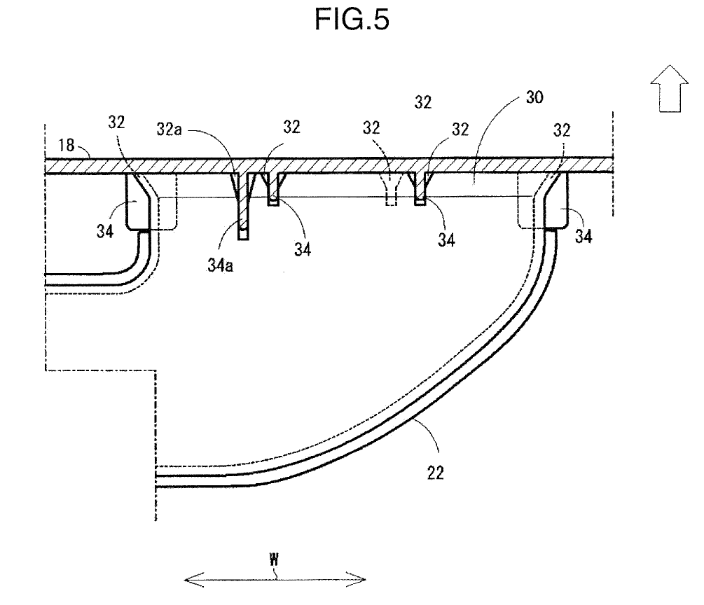

As shown in FIG. 5 which is an enlarged view showing the air inlet port 30 and a vicinity thereof (a fragmentary sectional view taken along Y-Y in FIG. 2), a plurality of cutouts 32 (including a cutout 32a) are formed in an peripheral edge of the air inlet port 30 of the fresh air duct 22. Each of the cutouts 32 is formed to be roughly engageable with a corresponding one of a plurality of reinforcing ribs 34 (including a reinforcing rib 34a) formed around the fresh air duct-connection opening 26 of the shroud frame 18. Further, each of the cutouts 32 is formed to have a width which gradually increases in a direction from a distal end (i.e., rearmost end) toward a base end (i.e., frontmost end) thereof in order to facilitate the engagement with the corresponding one of the ribs 34. In an operation of assembling the fresh air duct 22 to the shroud frame 18, the cutouts 32 are easily brought into an engagement with the respective ribs 34 to allow the air inlet port 30 of the fresh air duct 22 to be accurately guided relative to the fresh air duct-connection opening 26 of the shroud frame 18.

The rib 34a is formed to have a length greater than that of remaining ribs 34 in the frontward-rearward (i.e., longitudinal) direction of the vehicle in order to increase a level of reinforcement depending on a position and/or shape of the fresh air duct-connection opening 26 of the shroud frame 18. Therefore, the cutout 32a corresponding to the rib 34a is formed to have a length (depth) greater than that of remaining cutouts 32 in the longitudinal direction of the vehicle. Thus, after a frontmost end of the cutout 32a is brought into engagement with the rearmost end of the rib 34a, the fresh air duct 22 can be moved in the frontward direction of the vehicle to bring all the remaining cutouts 32 into engagement with the corresponding ones of the remaining ribs 34.

As shown in FIG. 4, the fresh air duct 22 is formed and arranged to extend from the air inlet port 30 located on the side of the first end of the upper portion of the shroud frame 18 toward the air cleaner 20 located on the side of the second end of the upper portion of the shroud frame 18, in the lateral direction W of the vehicle approximately linearly. Further, as shown in FIGS. 1 and 3, a portion of the fresh air duct 22 is formed and arranged to extend while being located between the upper deck 28 of the shroud frame 18 and an upper end of the radiator 12. An outlet port 36 of the fresh air duct 22 is connected to an inlet port 38 of the air cleaner 20. This makes it possible to ensure the long linear shape of the fresh air duct 22 without reducing a front upper space of the engine compartment (i.e., a space on a rearward and upward side relative to the shroud frame 18). That is, the fresh air duct 22 has a relatively low flow resistance and a relatively high function of reducing air intake noise. As shown in FIG. 1, in addition to above structure, a resonator (resonance silencer) 39 is connected to a lower portion of the fresh air duct 22 in order to further the reduce air intake noise.

As shown in FIGS. 1 and 4, the fresh air duct 22 is formed by connecting a duct member 40 on the side of the air inlet port 30 (the duct member 40 will hereinafter be referred to as “inlet-side duct member 40”; which corresponds to the first duct member recited in the appended claims), and a duct member 42 on the side of the air cleaner 20 (the duct member 42 will hereinafter be referred to as “outlet-side duct member 42”; which corresponds to the second duct member set forth in the appended claims).

The inlet-side duct member 40 is made of a resin material, and formed by combining a pair of half molded components 40a, 40b each having an inner surface formed using a molding die, as shown in FIG. 3. This is intended to increase a dimensional accuracy of an internal passage of the inlet-side duct member 40 and form an inner surface of the inlet-side duct member 40 into a shape having a lower flow resistance. For example, in a blow molding process which is commonly used for forming a cylindrical-shaped resin member, although an outer surface can be formed into a desired shape with a high degree of accuracy, a shaping accuracy of an inner surface is poor as compared with the outer surface. In this embodiment, an injection molding process as a die forming process capable of forming an inner surface into a shape having a lower flow resistance is used for forming each of the half molded members 40a, 40b, and the half molded members 40a, 40b are combined together to obtain the inlet-side duct member 40 having a higher dimensional accuracy and a lower flow resistance.

More specifically, as shown in FIGS. 1 to 3, the upper half molded component 40a of the inlet-side duct member 40 is formed with a bracket portion 40c for allowing the inlet-side duct member 40 to be fixed to the shroud frame 18. Further, as shown in FIG. 3, a plate member 40d is provided. An upper end of the plate member 40d is fixed to the upper deck 28 of the shroud frame 18 through a rivet 44, so that the inlet-side duct member 40 is fixed to the shroud frame 18. Although not specifically illustrated, a lower end of the plate member 40d is fixedly connected to a front surface of an after-mentioned upper wall of the bracket portion 40c.

The bracket portion 40c has an upper wall (corresponds to the support portion recited in the appended claims) defining a groove 40e opened upwardly and adapted to hold a hose-like member or a harness-like member. In FIGS. 1 and 3, the groove 40e holds two air-releasing hoses 46 as a part of a coolant circuit. As shown in FIG. 3, the plate member 40d is curved to protrude above the groove 40e in order to press the two hoses 46 to prevent drop-off thereof from the groove 40e, and the upper wall of the bracket portion 40c is formed such that a portion thereof is located in opposed relation to the curved portion of the plate member 40d to narrow a space above the groove 40e. This makes it possible to eliminate a need for providing an additional member for holding a hose-like member or a harness-like member, to the vehicle front structure 10.

As shown in FIG. 3, the inlet-side duct member 40 is fixed to the shroud frame 18 to define a space 48 between an upper surface of the inlet-side duct member 40 and the upper deck 28 of the shroud frame 18. Specifically, the fresh air duct-connection opening 26 is formed in the shroud frame 18 at a position having a potential to define the space 48, and the bracket portion 40c is formed on the inlet-side duct member 40 at a position on a rearward side of the vehicle. For example, a harness 50 for turning on headlights (not shown) is laid out in the space 48, as shown in FIG. 3. In this embodiment, the harness 50 is fixed to the upper deck 28 of the shroud frame 18 through a support band 52. This makes it possible to ensure a space (partially surrounded space) for laying out the harness 50 or the like. That is, a need for defining an additional space for laying out the harness 50 or the like can be eliminated.

As shown in FIGS. 1 and 4, the outlet-side duct member 42 is provided with a bellows portion 42a. The bellows portion 42a is provided in consideration of assembling efficiency. An operation of attaching the vehicle front structure 10 to the vehicle body will be described below. The shroud frame 18 (including the radiator 12 and the fan shroud 16) and the air cleaner 20 are firstly fixed to the vehicle body. Then, the inlet-side duct member 40 of the fresh air duct 22 is fixed to the shroud frame 18. Then, the outlet-side duct member 42 is disposed between the air cleaner 20 and the inlet-side duct member 40 while shrinking the bellows portion 42a. Thus, the outlet-side duct member 42 can be readily connected to each of the air cleaner 20 and the inlet-side duct member 40 by returning the bellows portion 42a to its original shape. If the outlet-side duct member 42 is devoid of the bellows portion 42a, the connection operation is not easy because it has to be performed while bending the outlet-side duct member 42.

In addition, the bellows portion 42a can absorb vibration to be transmitted from the air cleaner 20 to the inlet-side duct member 40 and further to the shroud frame 18 (vibration caused by an operation of the air cleaner 20, to suppress the vibration transmission. This makes it possible to reduce vibration of the inlet-side duct member 40 in a suspended state.

In this embodiment, the fresh air duct 22 is formed in a longer linear shape in the lateral direction W of the vehicle, and disposed above the radiator 12. This makes it possible to endure higher air intake efficiency based on a lower flow resistance and reduce air intake noise based on a longer air intake passage without the problem about reducing the front upper space of the engine compartment as in the fresh air duct disclosed in the Patent Publication 1.

Although the present invention has been described based on the above embodiment thereof, it is understood that the present invention is not limited the specific embodiment.

For example, while the fresh air duct in the above embodiment is formed by connecting two duct members, the fresh air duct may be a single duct, or may be formed by connecting three or more duct members.

In the above embodiment, only a portion of the fresh air duct (one of two duct members) is formed by combining a pair of half molded components made of a resin material. Alternatively, the entire fresh air duct may be formed by combining a pair of half molded components made of a resin material. In this case, the fresh air duct can have a lower flow resistance as compared with the above embodiment.

In the above embodiment, the support portion (the upper wall defining the groove 40e) adapted to hold a hose-like member or a harness-like member is formed in the bracket portion 40c. Alternatively, the support portion may be formed in any suitable portion of the fresh air duct other than the bracket portion.

As described above, the present invention can provide a vehicle front structure comprising a fresh air duct capable of ensuring high air intake efficiency and reducing air intake noise without reducing a front upper space of an engine compartment. Thus, the present invention can be suitably used in the field of a vehicle having an engine compartment arranged in a front thereof.

The present invention can be summarized as follows.

A vehicle front structure of the present invention comprising a rectangular frame-shaped shroud frame disposed in a front of an engine compartment to internally support a radiator, and a fresh air duct disposed to allow an air inlet port thereof to be opened in a frontward direction of a vehicle, and supply intake air to an engine via an air cleaner, wherein the shroud frame has a fresh air duct-connection opening formed in an upper portion thereof at a position on the side of a first one of opposite ends of the upper portion in a lateral direction of the vehicle, and the fresh air duct is disposed to allow the air inlet port to be connected to the fresh air duct-connection opening of the shroud frame, and extend in the lateral direction toward the other second end of the upper portion so as to be connected to the air cleaner disposed on the side of the second end, wherein at least a portion of the fresh air duct is disposed between an upper deck of the shroud frame and an upper end of the radiator located beneath the upper deck.

In the vehicle front structure of the present invention, at least a portion of the fresh air duct is disposed between the upper end of the radiator and the upper deck of the shroud frame internally supporting the radiator. Further, in order to reduce a flow resistance and increase an inner volume, the fresh air duct is disposed to allow the air inlet port to be located on the side of the first end of the upper portion of the shroud frame, and extend in the lateral direction toward the air cleaner disposed on the side of the second end of the upper portion of the shroud frame. This makes it possible to ensure high air intake efficiency and reduce air intake noise without reducing a front upper space of the engine compartment.

Preferably, in a second aspect of the vehicle front structure of the present invention, the fresh air duct is made of a resin material, and formed to have a support portion located on a rearward side thereof and adapted to hold a hose-like member or a harness-like member. This makes it possible to eliminate a need for providing an additional member for holding a hose-like member or a harness-like member.

Preferably, in a 3^{rd} aspect of the vehicle front structure, the support portion is adapted to hold a hose-like member, wherein the fresh air duct is formed and arranged to define a space for laying out a harness-like member therein, on a frontward side relative to the support portion and between the upper deck of the shroud frame and an upper surface of the fresh air duct. This makes it possible to ensure a space for laying out a harness-like member (i.e., to eliminate a need for providing an additional space for laying out a harness-like member).

Preferably, in a 4^{th} aspect of the vehicle front structure, at least a part of the flesh air duct is formed by combining a pair of half molded components each having an inner surface formed using a molding die. In this case, an inner surface of the fresh air duct can be formed in a shape having a lower flow resistance. This makes it possible to suppress air intake noise and enhance air intake efficiency.

Preferably, in a 5^{th} aspect of the vehicle front structure of the present invention, the shroud frame has a plurality of ribs formed on a rear surface thereof and around the fresh air duct-connection opening, and the fresh air duct has a plurality of cutouts formed in a peripheral edge of the air inlet port and adapted to guide respective ones of the plurality of ribs. The ribs can be used for accurately guiding the air inlet port of the fresh air duct relative to the fresh air duct-connection opening of the shroud frame during an operation of assembling the fresh air duct to the shroud frame, while reinforcing a region of the shroud frame around the fresh air duct-connection opening.

Preferably, in a 6^{th} aspect of the vehicle front structure, the fresh air duct includes a first duct member located on the side of the air inlet port, and a second duct member located on the side of the air cleaner and provided with a bellows portion. The bellows portion is provided in consideration of a case where the shroud frame and the air cleaner are firstly fixed to a vehicle body. In this case, the first duct member is attached to the shroud frame, and then the second duct member is disposed between the air cleaner and the first duct member while shrinking the bellows portion. Thus, the second duct member can be readily connected to each of the air cleaner and the first duct member by returning the bellows portion to its original shape. This makes it possible to facilitate an operation of attaching the fresh air duct. In addition, the bellows portion can absorb vibration to be transmitted from the air cleaner to the first duct member to suppress the vibration transmission.

This application is based on Japanese Patent Application Serial No. 2007-3200343, filed in Japan Patent Office on Dec. 12, 2007, the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

What is claimed is:

1. A vehicle front structure comprising:
a rectangular frame-shaped shroud frame disposed in a front of an engine compartment to internally support a radiator; and
a fresh air duct disposed to allow an air inlet port thereof to be opened in a frontward direction of a vehicle, and supply intake air to an engine via an air cleaner, wherein:
said shroud frame is formed with a fresh air duct-connection opening formed in an upper portion thereof at a position on a side of one of opposite ends of said upper portion in a lateral direction of the vehicle; and
said fresh air duct is disposed to allow said air inlet port to be connected to said fresh air duct-connection opening of said shroud frame, and extend in the lateral direction toward the other end of said upper portion so as to be connected to said air cleaner disposed on the side of said other end, at least a portion of said fresh air duct being disposed between an upper deck of said shroud frame and an upper end of said radiator located beneath said upper deck.

2. The vehicle front structure according to claim 1, wherein said fresh air duct is made of a resin material, and formed to have a support portion located on a rearward side thereof and adapted to hold a hose-like member or a harness-like member.

3. The vehicle front structure according to claim 2, wherein said support portion is adapted to hold a hose-like member, wherein said fresh air duct is formed and arranged to define a space for laying out a harness-like member therein, on a frontward side relative to said support portion and between said upper deck of said shroud frame and an upper surface of said fresh air duct.

4. The vehicle front structure according to claim 2, wherein at least a part of said flesh air duct is formed by combining a pair of half molded components each having an inner surface formed using a molding die.

5. The vehicle front structure according to claim 1, wherein:
said shroud frame has a plurality of ribs formed on a rear surface thereof and around said fresh air duct-connection opening; and
said fresh air duct has a plurality of cutouts formed in a peripheral edge of said air inlet port and adapted to guide respective ones of said plurality of ribs.

6. The vehicle front structure according to claim 2, wherein:
said shroud frame has a plurality of ribs formed on a rear surface thereof and around said fresh air duct-connection opening; and
said fresh air duct has a plurality of cutouts formed in a peripheral edge of said air inlet port and adapted to guide respective ones of said plurality of ribs.

8. The vehicle front structure according to claim 3, wherein:
said shroud frame has a plurality of ribs formed on a rear surface thereof and around said fresh air duct-connection opening; and
said fresh air duct has a plurality of cutouts formed in a peripheral edge of said air inlet port and adapted to guide respective ones of said plurality of ribs.

9. The vehicle front structure according to claim 4, wherein:
said shroud frame has a plurality of ribs formed on a rear surface thereof and around said fresh air duct-connection opening; and
said fresh air duct has a plurality of cutouts formed in a peripheral edge of said air inlet port and adapted to guide respective ones of said plurality of ribs.

10. The vehicle front structure according to claim 2, wherein said fresh air duct includes a first duct member located on the side of said air inlet port, and a second duct member located on the side of said air cleaner and provided with a bellows portion.

11. The vehicle front structure according to claim 3, wherein said fresh air duct includes a first duct member located on the side of said air inlet port, and a second duct member located on the side of said air cleaner and provided with a bellows portion.

12. The vehicle front structure according to claim 4, wherein said fresh air duct includes a first duct member located on the side of said air inlet port, and a second duct member located on the side of said air cleaner and provided with a bellows portion.

13. The vehicle front structure according to claim 5, wherein said fresh air duct includes a first duct member located on the side of said air inlet port, and a second duct member located on the side of said air cleaner and provided with a bellows portion.

14. The vehicle front structure according to claim 2, further comprising a plate member disposed to extend from said support portion so as to be connected to said upper deck of said shroud frame.

15. The vehicle front structure according to claim 14, wherein:
said support portion is formed to extend from a rear region of an upper surface of said fresh air duct approximately upwardly, and is formed with a groove opened upwardly; and
said plate member has an upper end and a lower end, said upper end being fixedly connected to said upper deck, said lower end being fixed to a front surface of said support portion and formed to extend in such a manner as to partly cover an opening of said groove in top plan view.
